(19) United States
(12) Patent Application Publication
(10) Pub. No.: US 2015/0107222 A1
(43) Pub. Date: Apr. 23, 2015

(54) THRUST REVERSER FAN RAMP PARTIALLY FORMED ON AFT END OF FAN CASE

(71) Applicant: ROHR, INC., Chula Vista, CA (US)

(72) Inventor: Michael Aten, San Diego, CA (US)

(73) Assignee: ROHR, INC., Chula Vista, CA (US)

(21) Appl. No.: 14/058,118

(22) Filed: Oct. 18, 2013

(51) Int. Cl. F02K 1/70

(52) U.S. Cl. CPC F02K 1/70; F05D 2240/129; F05D 2260/901
USPC 60/226.2; 60/226.1

(57) ABSTRACT

A fan ramp aerodynamically guides bypass duct air from the aft end of the fan case to the forward end of the cascades. To improve packaging of the thrust reverser assembly, the fan ramp begins on the interior of the fan case n continues onto the structure surrounding the cascade.

### FIELD

The present disclosure relates to nacelles for turbofan aircraft propulsion systems, and more particularly to thrust reverser assemblies for the same.

### BACKGROUND

Nacelles for turbofan aircraft propulsion systems (such as those that power modern commercial airliners) typically include thrust reversing assemblies. Thrust reversers typically include one or more cascades which guide fan air out of the thrust reverser in an outward and forward direction to generate reverse thrust. The fan air flows within a duct formed by the nacelle and surrounding the engine. During thrust reverser deployment, the fan air is blocked within the duct and turned toward the cascades with the help of blocker doors.

### SUMMARY

An aircraft propulsion system is disclosed. The aircraft propulsion system may comprise an annular fan case that houses a fan, the fan case comprising a radially interior surface and a radially exterior surface, the radially interior surface of the fan case deviating radially outward from an ideal loft surface that begins forward of an aft end of the fan case such that the fan case comprises a portion of a fan ramp. The fan ramp may aerodynamically guide air in a bypass air duct to a forward portion of a cascade. The ideal loft surface may be defined as a line extending between a portion of the fan case that is forward of an axial end of the fan case and a forward portion of a blocker door. The radially interior surface of the fan case may be curved. The radially interior surface of the fan case may curve radially outward to form a portion of the fan ramp. The aircraft propulsion system may further comprise a thrust reverser assembly that includes the cascade and a torque box at least partially surrounding the cascade and supporting the cascade. The aircraft propulsion system may further comprise a gas turbine engine. The bypass duct may be formed around a gas turbine engine. The aircraft propulsion system may further comprise a fan that drives air through the bypass duct. The aircraft propulsion system may further comprise a translating sleeve comprising a portion of a thrust reversing assembly that may be shifted aft to expose the fan ramp to a bypass air duct.

An aircraft propulsion system is disclosed. The aircraft propulsion system may comprise a gas turbine engine, a bypass air duct formed around the engine, a fan coupled to the engine that drives bypass air through the bypass air duct, an annular fan case located radially external of the fan with a radially interior surface defining at least in part the bypass duct, a thrust reverser assembly including a cascade and torque box at least partially surrounding the cascade and supporting it, and/or a fan ramp including a continuously curved aerodynamic surface extending from a point forward of an aft end of the interior surface of the fan case to the forward portion of the cascade and which aerodynamically guides air in the bypass duct from the fan case to the cascade forward portion, and, wherein the fan ramp is formed at least in part on the fan case. The radially interior surface of the fan case may deviate radially outward from an ideal loft surface that begins forward of an aft end of the fan case such that the fan case comprises a portion of the fan ramp. The ideal loft surface may be defined, in cross-section, as a line extending between a portion of the fan case that is forward of an axial end of the fan case and a forward portion of a blocker door. The radially interior surface of the km case may be curved. The radially interior surface of the fan case may curve radially outward to form a portion of the fan ramp. The aircraft propulsion system may further comprise an inner fixed structure formed about the gas turbine engine and defining at least in part the bypass duct. The aircraft propulsion system may further comprise a translating sleeve comprising a portion of a thrust reversing assembly that may be shifted aft to expose the fan ramp to the bypass air duct. The translating sleeve may he shifted forward to cover the fan ramp.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates a schematic cross-sectional view of a prior art aircraft propulsion system having a thrust reversing assembly in a stowed position;

FIG. 1B illustrates a schematic cross-sectional view of a prior art aircraft propulsion system having a thrust reversing assembly in a deployed position;

FIG. 2 illustrates a schematic cross-sectional view of a prior art aircraft propulsion system fan ramp;

FIG. 3 illustrates, in accordance with various embodiments, a perspective cutaway view of an aircraft propulsion system having a fan ramp partially formed on an aft end of a fan case;

FIG. 4 illustrates, in accordance with various embodiments, a schematic cross-sectional view of an aircraft propulsion system having a fan ramp partially formed on an aft end of a fan case, wherein the thrust reversing assembly is stowed; and

FIG. 5 illustrates, in accordance with various embodiments, a schematic cross-sectional view of an aircraft propulsion system having a fan ramp partially formed on an aft end of a fan case, wherein the thrust reversing assembly is deployed.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical., chemical and mechanical changes may be made without departing from the spirit and scope of the inventions. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced con tact or minimal contact.

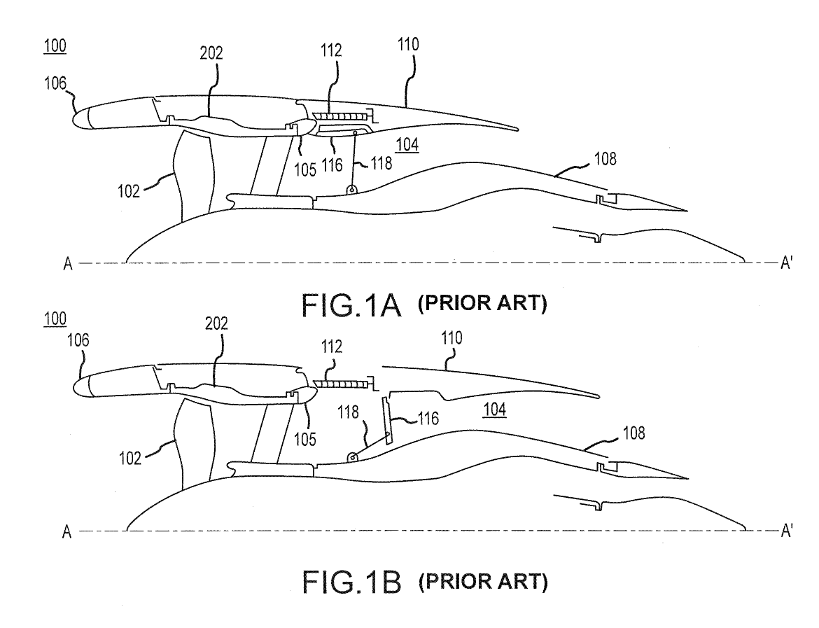

As used herein, “aft” refers to the direction associated with the tail (e.g., the back end) of an aircraft, or generally, to the direction of exhaust of the gas turbine. As used herein, “forward” refers to the directed associated with the nose (e.g., the front end) of an aircraft, or generally, to the direction of flight or motion. For example, with reference to FIG. 1, point A is forward of point A′ along axis A-A′.

With reference now to FIG. 1A, a partial cross-section of a jet aircraft propulsion system nacelle 100 is shown. The nacelle 100 may extend from forward to aft along the axis A-A′. In flight, air from point A may now around and/or through the propulsion system in the direction from point A to point A′.

The nacelle 100 may generally function to package a gas turbine engine and a fan or turbofan 102, and may guide air around the external portion of the nacelle 100 and internally through the nacelle 100 to define the bypass duct 104.

The nacelle 100 may include an air inlet 106 through which air may enter the nacelle 100. Some portion of airflow may enter the gas turbine engine, and some portion of airflow may flow through the bypass air duct 104. An inner fixed structure (“IFS”) 108 may define an inner airflow surface of the bypass air duct 104 and may be disposed coaxially about the gas turbine engine. The gas turbine engine may burn a hydrocarbon fuel in the presence of compressed air to generate exhaust gas. The exhaust gas may drive a turbine, which may, through a shaft, drive the turbofan 102 at the forward portion of the nacelle 100. The turbofan 102 may rotate to generate bypass fan airflow in a bypass air duct 104.

The nacelle 100 may further comprise a thrust reversing assembly or a thrust reverser. The thrust reversing assembly may comprise a plurality of thrust reversing components, including, for example, a translating sleeve 110, a cascade 112, one or more blocker doors 116, and/or one or more drag links 118. The blocker door 116 may be coupled to the IFS 108 by the drag link 118.

Generally, with reference to FIG. 1B, during a thrust reversing operation, the blocker door 116 may deploy from a stowed position to block bypass air flowing through the bypass air duct 104, In particular, the translating sleeve 110 may translate aft. As the translating sleeve 110 moves aft, the blocker door 116, which is coupled to the translating sleeve 110, may translate aft as well. The drag link 118 may, however, remain fixed to the IFS 108.

Thus, as the blocker door 116 translates aft with the translating sleeve 110, the drag link 118 may pull the blocker door 116 radially inward into a deployed position. As shown, in a deployed position, the blocker door 116 may project radially within the bypass duct 104 to block at least a portion of the fan air flow in the bypass air duct 104.

As air enters the bypass air duct 104, a curved structure or “fan ramp” 105 may channel air into the cascade 112. The blocker door 116 may, in addition, redirect fan air into the cascade 112. The cascade 112 may therefore channel fan air out of the nacelle 100 in a forward direction to generate reverse thrust.

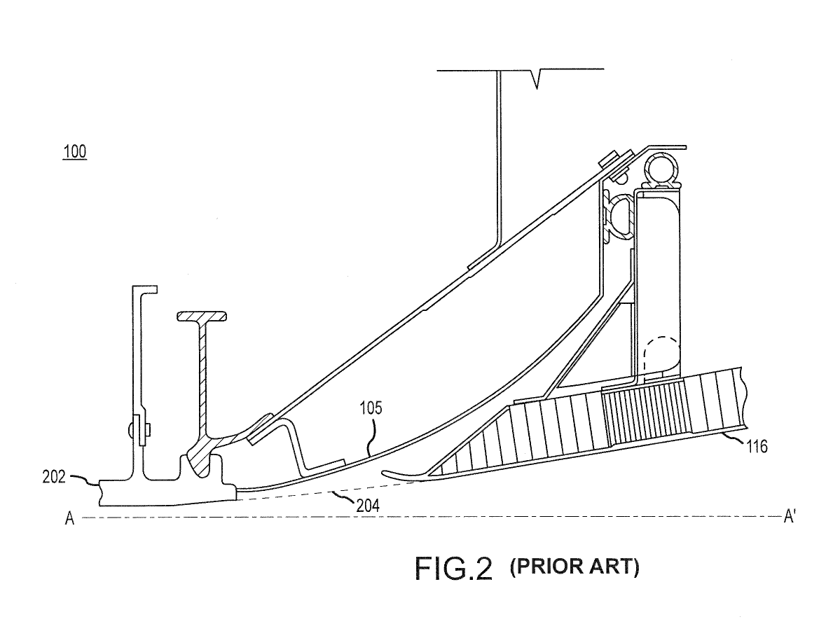

With reference to FIG. 2, a portion of a prior art nacelle 100 is shown in greater detail. Specifically, a prior art fan case 202, fan ramp 105, and blocker door 116 are shown. In general, the fan case 202 may compose art annular or cylindrical structure that surrounds the fan 102 and functions, in part, as a structural containment to protect the aircraft in the unlikely event of a fan blade failure. The fan case 202 may therefore comprise an inner surface and an outer surface. The inner surface may comprise a constant. (or substantially constant) radius. The inner surface of the fan case 202 normally does not include any curvature and is substantially flat.

The ideal air flow through the fan duct 104 defines loft surfaces or loft lines when viewed as two dimensional representations of the fan duct geometry and air flow) and is a product of the fan duct geometry including all the protrusions into the air flow and steps and gaps between surfaces. FIG. 2 illustrates how the air ideally flows between the hen case 202 and the blocker doors 116 when the blocker doors are stowed through the depiction of loft line 204. Ideally the air flows smoothly and in a straight line over the gap beginning at the aft end of the fan case 204 until the forward edge of the blocker door 116, as illustrated. Note that the fan case 202 interior surface defines the loft line as the radially exterior boundary of the bypass air duct 104, as does the blocker door bottom surface. In the event of thrust reverser deployment, the loft lines change as now the air flow in the bypass air duct is redirected radially outward through the cascades 112. During this reverse thrust operation, the fan ramp 105 now helps define the loft line as air flows adjacent to it in order to make the curve towards the cascades 112. However, in normal thrust operation, when the thrust reverser is stowed, the fan ramp 105 is by definition not part of the loft lines. Thus, the beginning of the fan ramp 105 surface can be defined as the point where the loft lines during reverse thruster deployment begin to depart from the loft lines during normal forward thrust operation in order for the air flow to turn towards the cascades 112.

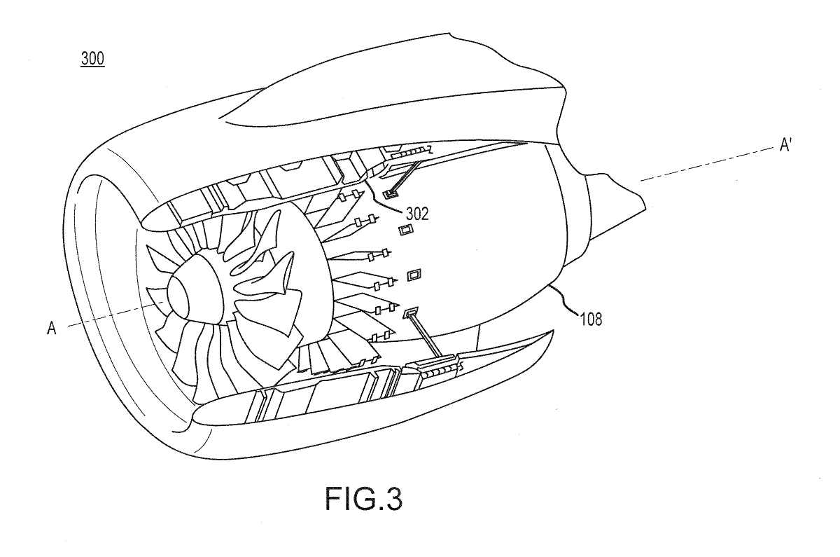

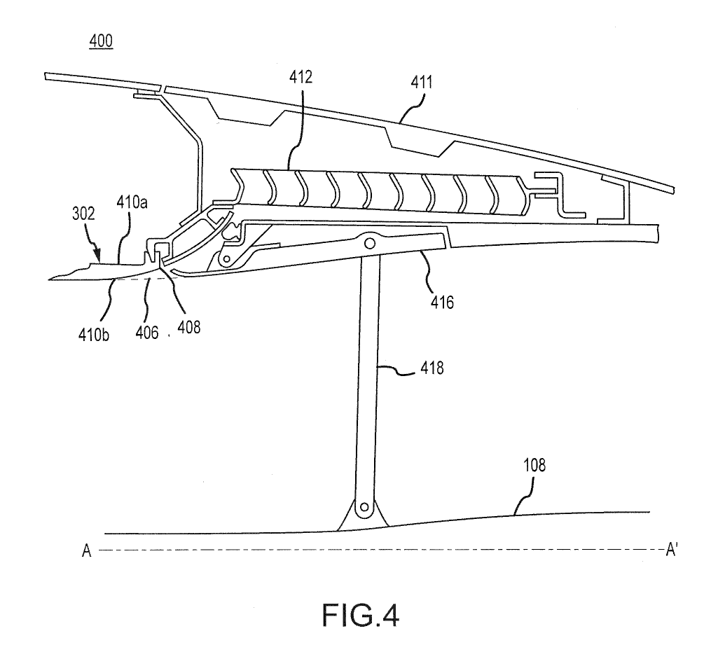

Now, as shown with reference to FIGS. 3-5, a perspective view of a partially cutaway nacelle 300 is shown. The nacelle 300 may include a cascade 412, a blocker door 416, a drag link 418, an IFS 108, and a translating sleeve 411. In addition, unlike the nacelle 100 described above, the nacelle 300 may comprise a fan case 410 having a curvature. The fan case 302 may comprise a radially interior surface 410b and a radially exterior surface 410a. The radially interior surface 410b of the fan case 302 may deviate from the loft line 406 for normal forward thrust operation illustrated in FIG. 4, the deviation commencing forward of an aft end 408 of the fan case 302. This (levitation of the aft end of fan case 302 from the loft line 406 is a curve which will help define the air flow in the bypass duct durying reverse thrust operation and help to turn the air flow towards the cascades 412. In this manner, the curvature on the aft end of fan case 302 may constitute part of fan ramp 502. Stated another way, in various embodiments, a fan ramp's forward most point is the forward most point where its loft line deviates from the ideal loft surface 406. As shown in FIG. 4, radially interior surface 410b of fan case 302 deviates from the loft line 406 and, accordingly, radially interior surface 410b of fan case 302 comprises a portion of the fan ramp 502.

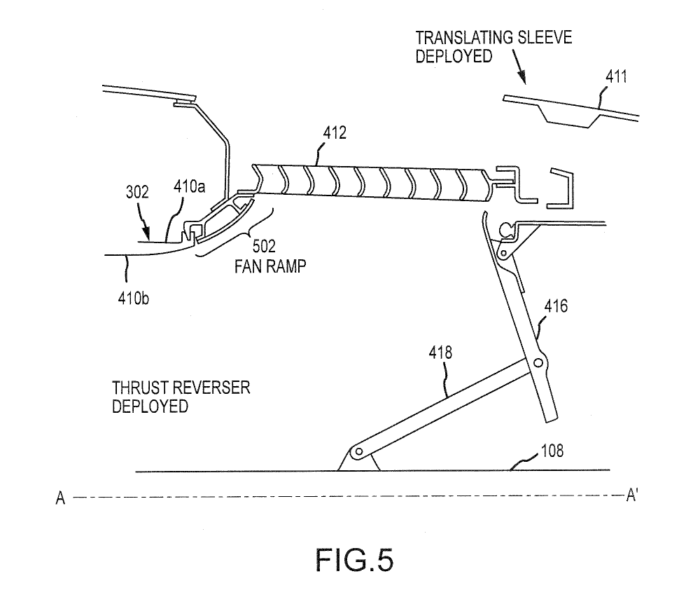

Again, as shown in greater detail with respect to FIGS. 4 and 5 (showing a thrust reversing assembly 400 in a stowed and deployed configuration, respectively), the fan case 302 may terminate at an aft end 408 that is aft of a deviation of the radially interior surface 410b of the fan case 302 from the loft line 406. Thus, the fan can case 302 may contribute to the curvature of the fan ramp 502. In other words, the fan ramp 502 may be formed in part on the fan case 302.

As a result of the fan ramp sharing described above, a variety of system components (e.g., a torque box, the cascade 412, and the like) may be allowed to occupy a more forward portion of the nacelle 300 (in comparison to the nacelle 100). In addition, as the fan ramp 502 occupies a more forward position than is conventional, a torque box may also occupy a more forward position than is conventional and/or its dimensions (in particular its width) reduced during construction. The aerodynamic geometry of the nacelle 300 may be improved over that associated with the nacelle 100 as well. For example, the nacelle 300 may sweep more steeply aft than the nacelle 100.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Different cross-hatching is used throughout the figures to denote different parts but not necessarily to denote the same or different materials. Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” any other variation thereof, are intended to cover a non-exclusive inclusion, such that a process, method, article, or apparatus that comprises a list of elements does not include only those elements but may include other elements not expressly listed or inherent to such process, method, article, or apparatus.

I claim:

1. An aircraft propulsion system comprising:
an annular fan case that houses a fan, the fan case comprising a radially interior surface and a radially exterior surface, the radially interior surface of the fan case deviating radially outward from an ideal loft surface that begins forward of an aft end of the fan case such that the fan case comprises a portion of a fan ramp.

2. The aircraft propulsion system of claim 1, wherein the fan ramp aerodynamically guides air in a bypass air duct to a forward portion of a cascade.

3. The aircraft propulsion system of claim 1, wherein the ideal loft surface is defined as a line extending between a portion of the fan case that is forward of an axial end of the fan case and a forward portion of a blocker door.

4. The aircraft propulsion system of claim 1, wherein the radially interior surface of the fan case is curved.

5. The aircraft propulsion system of claim 1, wherein the radially interior surface of the fan case curves radially outward to form a portion of the fan ramp.

6. The aircraft propulsion system of claim 1, further comprising a thrust reverser assembly that includes the cascade and a torque box at least partially surrounding the cascade and supporting the cascade.

7. The aircraft propulsion system of claim 1, further comprising a as turbine engine,

8. The aircraft propulsion system of claim 1, wherein the bypass duct is formed around a gas turbine engine.

9. The aircraft propulsion system of claim 1, further comprising a fan that drives air through the bypass duct.

10. The aircraft propulsion system of claim 1, wherein translating sleeve comprising a portion of a thrust reversing assembly is shifted aft to expose the fan ramp to a bypass air duct.

11. An aircraft propulsion system comprising:
a gas turbine engine;
a bypass air duct formed around the engine;
a fan coupled to the engine that drives bypass air through the bypass air duct;
an annular fan case located radially external of the fan with a radially interior surface, defining at least in part the bypass duct;
a thrust reverser assembly including a cascade and torque box at least partially supporting the cascade; and
a fan ramp including a continuously curved aerodynamic surface extending from a point forward of an aft end of the interior surface of the fan case to the forward portion of the cascade and which aerodynamically guides air in the bypass duct from the fan case to the cascade forward portion, and, wherein the fan ramp is formed at least in part on the fan case.

12. The aircraft propulsion system of claim 8, wherein the radially interior surface, of the fan case deviates radially outward from an ideal loft surface that begins forward of an aft end of the fan case such that the fan case comprises a portion of the fan ramp

13. The aircraft propulsion system of claim 9, wherein the ideal loft surface is defined, in cross-section, as a line extending between a portion of the fan case that is forward of an axial end of the fan case and a forward portion of a blocker door.

14. The aircraft propulsion system of claim 9, wherein the radially interior surface of the fan case is curved.

15. The aircraft propulsion system of claim 9, wherein the radially interior surface of the fan case curves radially outward to form a portion of the fan ramp.

16. The aircraft propulsion system of claim 8, further comprising an inner fixed structure formed about the gas turbine engine and defining at least in part the bypass duct.

17. The aircraft propulsion system of claim 8, wherein a translating sleeve comprising a portion of a thrust reversing assembly is shifted aft to expose the fan ramp to the bypass air duct.

18. The aircraft propulsion system of claim 14, wherein the translating sleeve is shifted forward to cover the fan ramp.
